(19) United States
(12) Patent Application Publication
(10) Pub. No.: US 2003/0000149 A1
(43) Pub. Date: Jan. 2, 2003

(54) Linearly actuated locking device for transit vehicle door system

(76) Inventors: Robert L. Oakley, Chicago, IL (US); Robert Payne, Greensborough (AU)

Correspondence Address: JAMES RAY & ASSOCIATES, 2640 Pitcairn Road, Monroeville, PA, 15146, US

(21) Appl. No.: 10/078,214

(22) Filed: Feb. 19, 2002

Related U.S. Application Data
(60) Provisional application No. 60/271,350, filed on Feb. 23, 2001.

(51) Int. Cl. E05F 1/00

(52) U.S. Cl. 49/449

(57) ABSTRACT

A locking device for attachment to a fixed portion of a transit vehicle door system is for locking one or more doors of the transit vehicle door system in either a fully locked position or a pushback lock position. The locking device has a simple lock arm, biased toward the locking position and rotatably attached to the fixed portion of the transit vehicle door system at a first pivot of the rotary lock arm, the rotary lock arm having at least one door engagement portion for engaging a portion of the door(s) for locking the door(s) when the rotary lock arm is in at least one of the locking position and the pushback position thereof. A linear actuator, rotating the lock arm to the unlocked position when energized, is attached to the fixed portion of the transit vehicle door system and connected to a second pivot of the lock arm, said second pivot offset from the first pivot. A lock actuator sensing switch provides a feedback on the actuator position to the transit vehicle control system. Means are provided within linear actuator to manually rotate lock arm toward unlocked position for opening doors during an emergency.

### CROSS-REFERENCE TO RELATED APPLICATION

The invention taught in this patent application is closely related to the invention taught in the following co-pending U.S. Provisional Patent Application Serial No. 60/271,350 and was filed on Feb. 23, 2001. All the teachings therein are incorporated into this application by reference thereto.

### FIELD OF THE INVENTION

The present invention relates, in general, to transit vehicle door systems and, more particularly, the instant invention relates to linearly actuated transit vehicle door locks having a pushback feature.

### BACKGROUND OF THE INVENTION

Door locks for transit vehicles are a major operational concern, particularly, to the mass transit industry. These door locks must provide a fail-proof system for locking of the door panel in the event of a door mechanism failure. This is required in order to prevent unintentional opening movement of such doors which would permit a passenger to fall out of the vehicle when it is in motion. Nevertheless, these doors must allow for normal door movement upon receipt of the legal open command.

This situation is exacerbated by the fact that certain permitted lateral movement of the doors in the closed and locked position exists. This is due to overall system tolerances as well as preload between door edges typically used in a mass transit vehicle. Such lateral movement produces preload forces which are exerted on the lock mechanism prior to the door opening. Furthermore, in cases where excessive traffic loads exist, passengers may be pressing against the doors thereby resulting in an undesirable increase in preload forces acting on the door lock mechanism.

Many prior art door systems have quite complex locks which exhibit numerous failure points. An example of a prior art door lock system is provided by U.S. Pat. No. 6,139,073 “LOCK ASSEMBLY” utilizing linearly moving primary and secondary components and various means to minimize frictional forces acting on the moving components. It can be seen that there is a need for a simple, reliable, door lock.

To minimize potential hazards encountered by the passenger during the door panel closing, it is also desirable for a locking system for transit vehicle doors to have a pushback feature. The pushback feature is provided to allow a person who has a limb, garment or carried object, that is caught by one or more closing doors, to push the doors open a small amount so that the limb, garment or carried object may be extracted. The amount the door panels can be opened when they are in the pushback region is limited to a small distance, typically in the range of from 5 cm to 10 cm, in order to prevent a person from falling out of the transit vehicle.

U.S. Pat. No. 6,032,416 entitled “TRANSIT VEHICLE DOOR” describes a transit vehicle door system having a lock which provides for a fully locked position and also a pushback position.

This patent has an interesting feature in that compression of the door seals is employed in the locking mechanism. The door seals bias the doors toward the open direction and that bias prevents a lock arm of the lock system from moving to the unlocking position. The teachings of U.S. Pat. No. 6,032,416 is incorporated herein by reference thereto.

For reasons of allowing emergency passenger egress, when an energy source may not be present to drive doors in the open direction, it is desirable for a locking system for a transit vehicle to be unlocked manually therein allowing for subsequent manual door movement toward an open direction.

### SUMMARY OF THE INVENTION

The present invention provides, according to a first aspect, a locking device for locking one or more doors of the transit vehicle door system in a fully locked position. The locking device has a rotary lock arm rotatably attached to the fixed portion of the transit vehicle door system at a first pivot of the rotary lock arm. The rotary lock arm has at least one door engagement portion for engaging a portion of the at least one door for locking such at least one door when the rotary lock arm is in such locking position. A linear actuator is attached to the fixed portion of the transit vehicle door system and to a second pivot of the rotary lock arm. The second pivot is offset from the first pivot. Such linear actuator for rotating the rotary lock arm to an unlocking position. There is a lock actuator sensor connectable to a transit vehicle door control system for determining the position of a moveable actuator portion. The lock arm is biased toward the locking position and is moved to the unlocking position when the actuator is energized. A lock actuator sensing switch provides a feedback on the actuator position to the transit vehicle control system.

According to a second aspect, the present invention provides a locking device for attachment to a fixed portion of a transit vehicle door system for locking at least one door of such transit vehicle door system in a pushback lock position. Such locking device includes a rotary lock arm rotatably attached to such fixed portion of such transit vehicle door system at a first pivot of such rotary lock arm. The rotary lock arm has at least one door engagement portion for engaging a portion of such at least one door for locking such at least one door when the rotary lock arm is in such pushback position thereof. A linear actuator is attached to such fixed portion of such transit vehicle door system and to a second pivot of the rotary lock arm. The second pivot is offset from the first pivot. Such linear actuator rotates the rotary lock arm to an unlocking position. There is a lock actuator sensor connectable to a transit vehicle door control system for determining a position of a moveable actuator portion. A lock biasing means is engageable with such rotary lock arm for biasing the rotary lock arm to the locking position. There is a pushback mechanism having a pushback biasing means engageable with such at least one door engaging portion of said pushback mechanism to move such door to such closed position. The pushback mechanism permitting a passenger to move such door a predetermined amount whereby such passenger may extract a limb, garment or carried object from such door panel.

### OBJECTS OF THE INVENTION

It is therefore one of the primary objects of the present invention to provide a simple and reliable lock for a transit vehicle door system

Another object of the present invention is to provide a lock for a transit vehicle door which cannot be unlocked unless a door opening signal is first sent to a door drive system for said door.

Still another object of the present invention is to provide a simple lock for a transit vehicle which locks the door(s) in a pushback mode so a passenger may open the door(s) slightly to remove a limb, garment portion or the like from the closed door(s).

Yet, another object of the present invention is to provide a simple lock for a transit vehicle which utilizes simple linear actuators for locking and unlocking door(s).

An additional object of the present invention is to provide a simple lock for transit vehicle having means to bias door(s) in the locked position.

Yet an additional object of the present invention is to provide a simple lock for transit vehicle having means to manually unlock door(s).

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is a pictorial view of a locking device for locking transit vehicle door in a closed position.

FIG. 2 is a pictorial view of a locking device for locking transit vehicle doors in a pushback lock position.

FIG. 3 is a pictorial view of the crossover of a pair of latches for the locking device of FIG. 2.

FIG. 3 is the horizontal view of the present invention taken along the lines 4-4 of FIG. 2 showing disposition of the wear spacers and guide pins.

### BRIEF DESCRIPTION OF THE PRESENTLY PREFERRED AND VARIOUS ALTERNATIVE EMBODIMENTS OF THE INVENTION

Prior to proceeding to the more detailed description of the instant invention, it should be noted that identical components which have identical functions have been identified with identical reference numerals throughout the several views illustrated in the drawing figures for the sake and clarity in understanding the invention. Furthermore, the detailed description of the present invention will be presented on a configuration of a biparting doors. It will be obvious to those persons who are skilled in the relevant art from that operation of the locking device in fully locked position or in pushback locked position for a single door will be identical other than the number of additional components associated with second door.

The invention disclosed herein overcomes locking device application difficulties through the use of a rotable locking arm and a at least one linear actuator pivotably attached to said locking arm. Employment of self lubricating means to reduce friction between moving components reduces application loads and further provides for ease of operation to move said locking arm away from door lock pins allowing doors to move toward open direction. Furthermore, employment of a simple rotable locking arm eliminates the need for multiple and more complex moving components. The design, therefore, provides the advantage of reliable operation and reduced design costs.

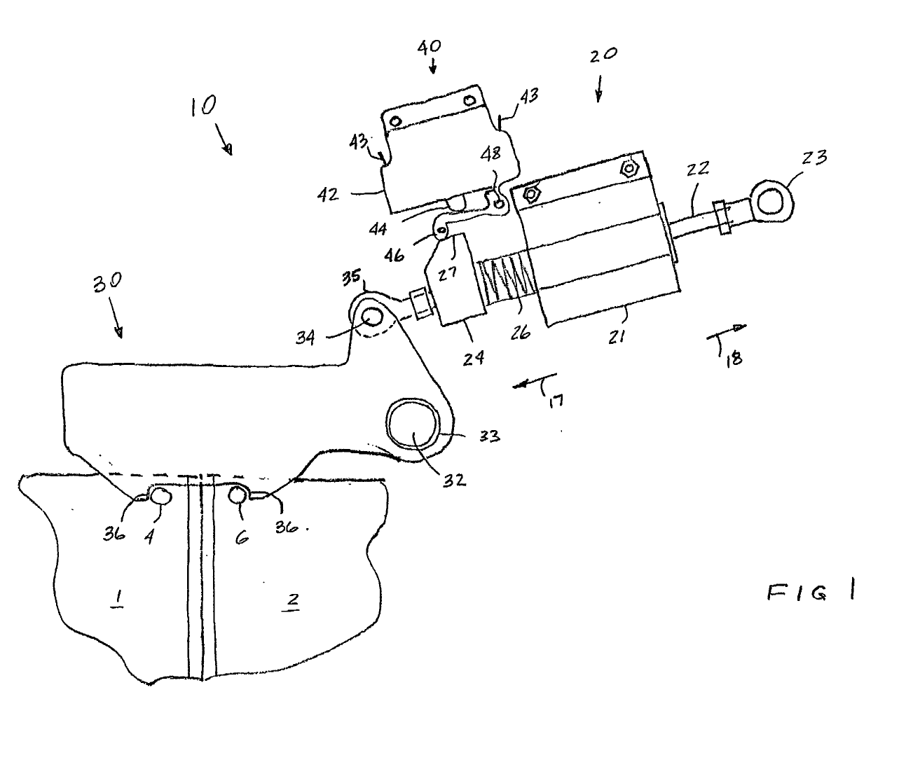

With respect to FIG. 1 there is shown a pictorial view of a locking device, generally designated 10, for a pair of transit vehicle doors 1 and 2. The locking device 10 is for attachment to a stationary part of the door system (not shown), at a point overhead of the door opening (not shown).

Locking device 10 has a rotary lock arm, generally designated 30, which is for capturing pin 4 on biparting door 1 and pin 6 on a biparting door 2. Door engagement portions 36 of rotary lock arm 30 engage pins 4 and 6 so that rotary lock arm 30 cannot be moved clockwise to an unlocking position without energizing a drive system for the doors 1 and 2 to compress door seals and move pins 4 and 6 toward each other.

Rotary lock arm 30 is pivotably attached to the overhead door structure (not shown) at first pivot 32. In the preferred embodiment, said pivot 32 is disposed within a self lubricating sleeve 33 to reduce friction forces during rotation of said lock arm 30 about said pivot 32. Lock arm 30 is further attached to actuator 20 at second pivot 34 offset from the first pivot 32 and disposed within articulated member 35 of the said linear actuator 20. In the preferred embodiment, articulated member 35 is of a spherical bearing type substantially minimizing directional loads imposed onto linear actuator 20 by the clock-wise rotation of the lock arm 30 during door unlocking motion.

Actuator 20, which may be a pneumatic cylinder, but preferably is a solenoid, has an energized portion 21 which exerts force on proximal moveable actuator portion 24. Energization of actuator 20 causes proximal portion 24 to move in the direction 18, thus rotating rotary lock arm 30 about first pivot 32 in a clockwise direction. Deenergization of actuator 20 permits actuator biasing means 26 to cause proximal portion 24 to move in the direction 17 to being rotary lock arm 30 into the locking position shown in FIG. 1. In the preferred embodiment actuator biasing means is a compression spring of predetermined length to positively bias lock arm 30 toward the lock position.

In the preferred embodiment at least one actuator sensor, generally designated 40, attached to the overhead door structure (not shown) and provides a signal indicating the position of the moveable actuator portion 24. Preferably, said sensor 40 includes a sensor actuator portion 46 pivotably connected to sensor housing 42 at pivot 48 and engaging a displaceable portion 44 to provide a signal indicating the position of the moveable actuator portion 24. Such actuator sensor 40 is connected to the control system for the door lock 10 through electrical terminals 43.

Actuator sensor 40, which may be an optical contactless type sensor, but preferably is a solid state switch having normally open contacts, having substantial current rating to disable control power within transit vehicle wherein door(s) has/have not reached closed and locked position.

An emergency release is, preferably, attached to distal moveable portion 22 to move both moveable portions, 22 and 24 in the direction 18 to cause clockwise (unlocking) rotation of rotary lock arm 30.

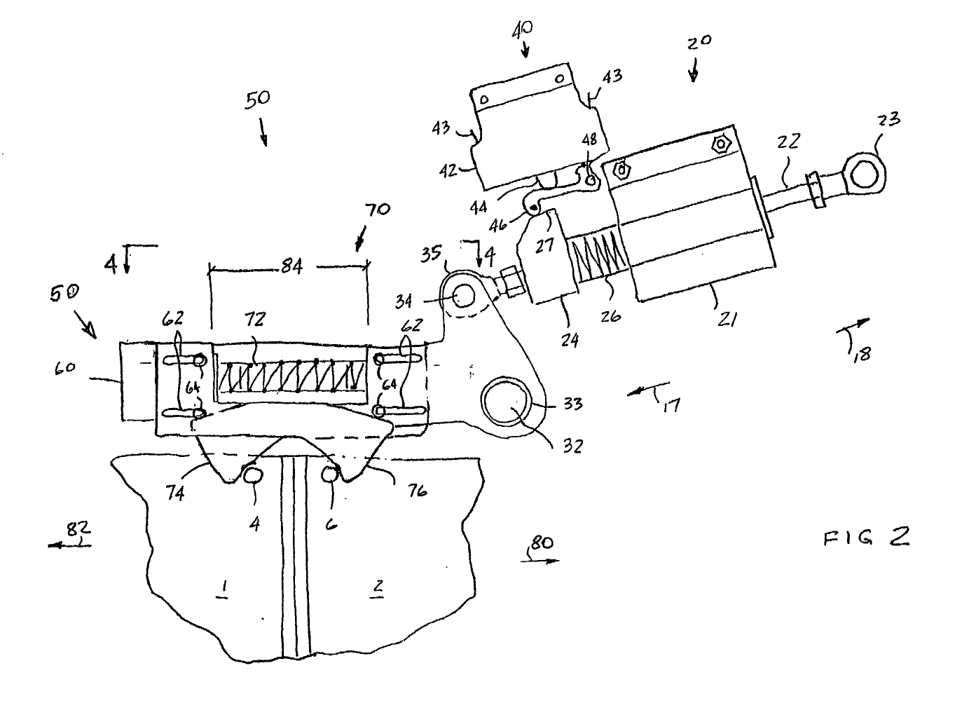

FIG. 2 illustrates a locking device, generally designated 50, having a pushback mechanism, generally designated 70, for locking a pair of biparting doors of a transit vehicle in a pushback lock position. Locking device 50 has a lock arm 60 which is pivotably attached to the overhead door structure at first pivot 32. It is also attached to actuator 20 at second articulated pivot 34 offset from first pivot 32 and disposed within articulated member 35. As for the system shown in FIG. 1, energization of actuator 20 causes proximal moveable portion 24 of actuator 20 to move in the direction 18 thus causing lock arm 60 to move clockwise for unlocking.

For locking the doors in a pushback position, pins 4 and 6 are captured by latch arms 74 and 76 respectively of pushback mechanism 70. These latch arms are relatively moveable, unlike the pin engagement portions 36 of rotary lock arm 30 discussed above.

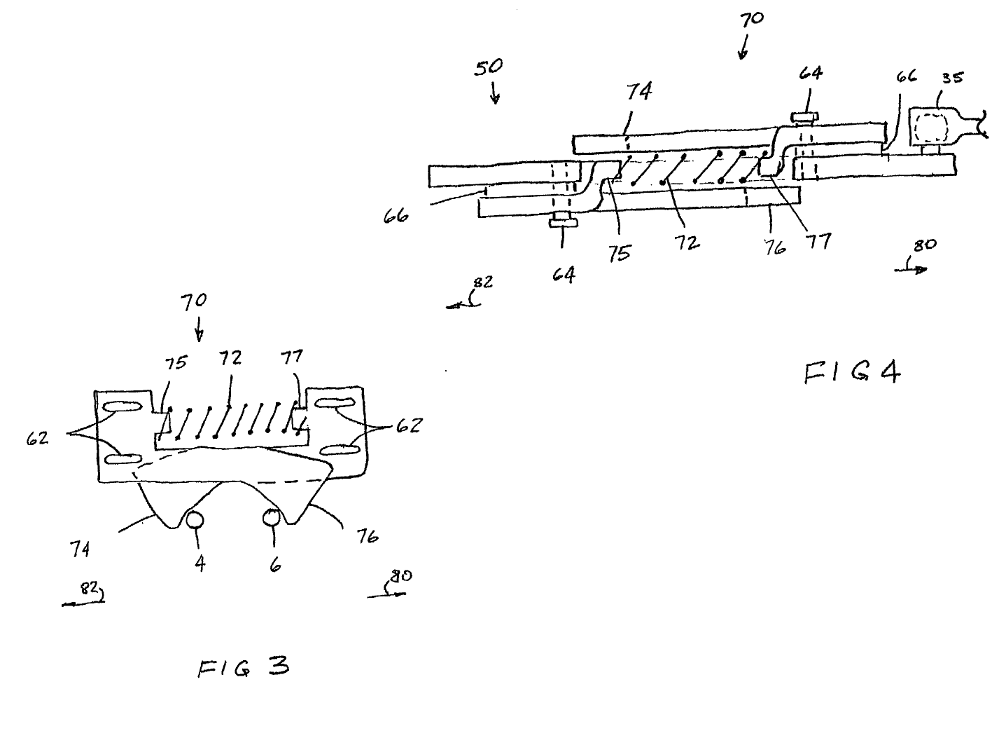

Additional details of the latch arms 74 and 76 are shown in FIG. 3 and FIG. 4, which also show the pushback bias means 72. In the preferred embodiment pushback bias means is a coiled compression spring with predetermined length 84 to provide for required movement of doors 1 and 2. Latch arm 74, which engages pin 4, has spring engaging portion 77. Latch arm 76, which engages pin 6, has spring engaging portion 75. Low friction means 66 are disposed between lock arm 60 and latch arms 74 and 76 to reducing friction forces between said lock arm 60 and latch arms 74 and 76. Furthermore, latch arms 74 and 76 are constrained to be moveable only in a linear direction 80 or 82 by the guides 62. Preferably, these guides are slots formed in latch arms 74 and 76. Furthermore, said slots 62 having predetermined length to cooperate in conjunction with the pushback biasing means 72.

In reference to FIG. 4, at least two guide pins 64 attached to lock arm 60 engage slots 62 to provide the required constraint allowing linear motion of latch arms 74 and 76 in directions 82 or 80 only in conjunction with guides 62.

A person skilled in the art will recognize that compression of spring 72 will cause latch arm 74 to move in the direction 80 and latch arm 76 to move in the direction 82, thus moving the doors apart. Furthermore, a passenger may force the doors 1 and 2 open a small amount, moving pin 4 to in the direction 82 and pin 6 in the direction 80, against the compression of spring 72 with doors returning to the pushback locked position upon the passenger releasing the doors.

While in accordance with patent statutes both a presently preferred and various alternative embodiments of the invention have been described in detail above, it should be understood that various other modifications and adaptations of the invention can be made by those persons skilled in the relevant art without departing from either the spirit of the invention and scope of the appended claims.

We claim:

1. A locking device for attachment to a fixed portion of a transit vehicle door system for locking at least one door of such transit vehicle door system in a fully locked position, said locking device comprising:
a rotary lock arm rotatably attached to such fixed portion of such transit vehicle door system at a first pivot of said rotary lock arm, said rotary lock arm having at least one door engagement portion for engaging a portion of such at least one door for locking such at least one door when said rotary lock arm is in said locking position thereof;
a linear actuator attached to such fixed portion of such transit vehicle door system and to a second pivot of said rotary lock arm, said second pivot offset from said first pivot, said linear actuator for rotating said rotary lock arm to an unlocking position;
a lock actuator sensor connectable to a transit vehicle door control system for determining a position of a moveable actuator portion; and
lock biasing means engageable with said rotary lock arm for biasing said rotary lock arm to said locking position;
whereby said rotary lock arm is biased towards at least one of said locking position when said actuator is not energized, and said rotary lock arm is moved to said unlocking position when said actuator is energized.

2. A locking device, according to claim 1, wherein said actuator is a solenoid.

3. A locking device, according to claim 1, wherein said actuator is a pneumatic cylinder.

4. A locking device, according to claim 1, wherein said locking device further includes a manual release attached to a moveable portion of said actuator.

5. A locking device, according to claim 1, wherein said lock biasing means is a coiled compression spring having a predetermined length.

6. A locking device, according to claim 5, wherein said predetermined length is at least sufficient to apply a predetermined force onto said rotary lock arm in said door locked position and for preventing door lock pins from moving laterally during transit vehicle motion.

7. A locking device, according to claim 5, wherein said predetermined length is at least sufficient is to allow for manual displacement of said movable actuator portion to cause rotation of said lock arm in such clockwise direction and for allowing manual emergency opening of such at least one door.

8. A locking device, according to claim 1, wherein said rotary lock arm includes at least one overhung pin engagement portion so that such at least one door cannot be opened unless a door seal on such at least one door is compressed.

9. A locking device, according to claim 1, wherein said lock actuator sensor is a solid state switch having a predetermined current rating to disable control power within such transit vehicle when such at least one door has not reached a closed and locked position.

10. A locking device, according to claim 1, wherein said lock actuator sensor is an optical contactless type sensor having a predetermined current rating to disable control power within such transit vehicle when such at least one door has not reached a closed and locked position.

11. A locking device, according to claim 1, wherein said first pivot is disposed within a self lubricating sleeve bearing, said bearing substantially reducing rotational frictional forces of said lock arm about said first pivot.

12. A locking device, according to claim 1, wherein said second pivot is disposed within an articulated spherical bearing to absorb frictional and rotational forces and for substantially eliminating influence of said forces during operation of said linear actuator.

13. A locking device, according to claim 9, wherein said solid state switch has normally open contacts converting to closed contacts in locking conditions and provides position status feedback to such control circuit of such transit vehicle.

14. A locking device for attachment to a fixed portion of a transit vehicle door system for locking at least one door of such transit vehicle door system in a pushback lock position, said locking device comprising:
a rotary lock arm rotatably attached to such fixed portion of such transit vehicle door system at a first pivot of said rotary lock arm, said rotary lock arm having at least one door engagement portion for engaging a portion of such at least one door for locking such at least one door when said rotary lock arm is in said pushback position thereof;
a linear actuator attached to such fixed portion of such transit vehicle door system and to a second pivot of said rotary lock arm, said second pivot offset from said first pivot, said linear actuator for rotating said rotary lock arm to an unlocking position;
a lock actuator sensor connectable to a transit vehicle door control system for determining a position of a moveable actuator portion;
lock biasing means engageable with said rotary lock arm for biasing said rotary lock arm to said locking position; and
a pushback mechanism having a pushback biasing means at least one door engaging portion of said pushback mechanism to move such door to such closed position, said pushback mechanism permitting a passenger to move such door a predetermined amount whereby such passenger may extract a limb, garment or carried object from such door panel.

15. A locking device, according to claim 14, wherein said pushback biasing means is a coil compression spring having a predetermined length at least sufficient to apply a predetermined force onto a latch arm engaging door pin attached to such at least one door substantially moving such at least one door toward such pushback locked direction upon compression of said the coil compression spring.

16. A locking device, according to claim 15, wherein said predetermined length of said coil compression spring is at least sufficient to allow for manual displacement of said latch arm and to allow for constrained manual opening of such at least one door in a pushback mode.

17. A locking mechanism, according to claim 14, wherein said pushback mechanism further includes at least one simple low friction spacer disposed between said lock arm and said latch arm for substantially reducing frictional forces of latch arm movement about said lock arm.

18. A locking device for attachment to a fixed portion of a transit vehicle door system for locking a pair of biparting door panels of such transit vehicle door system in a pushback lock position, said locking device comprising:
a rotary lock arm rotatably attached to such fixed portion of such transit vehicle door system at a first pivot of said rotary lock arm, said rotary lock arm having at least one door engagement portion for engaging a portion of such doors for locking such doors when said rotary lock arm is in said pushback position thereof;
a linear actuator attached to such fixed portion of such transit vehicle door system and to a second pivot of said rotary lock arm, said second pivot offset from said first pivot, said linear actuator for rotating said rotary lock arm to an unlocking position;
a lock actuator sensor for determining a position of said moveable actuator portion, said lock actuator sensor being connectable to such control system;
a lock biasing means for biasing said rotary lock arm to said locking position; and
a pushback mechanism having a pushback biasing means for biasing at least two door engaging portion of said pushback mechanism to move such doors to such closed position, said pushback mechanism permitting a passenger to move such doors a predetermined amount whereby such passenger may extract a limb, garment or carried object from such doors.

19. A locking device, according to claim 18, wherein said at least one door engaging portion of said pushback mechanism includes two door engaging portions, said door engaging portions crossing one above the other so that compression of said pushback spring biases said door engaging portions to bias said doors to such closed position.

20. A locking device, according to claim 19, wherein said actuator is a solenoid.
